(19) United States
(12) Patent Application Publication
(10) Pub. No.: US 2006/0231769 A1
(43) Pub. Date: Oct. 19, 2006

(54) Particle detection by electron multiplication

(76) Inventors: Richard Stresau, Sydney (AU); Kevin Hunter, Glenhaven (AU); Wayne Sheils, Winmalee (AU); Peter Raffin, Petersham (AU); Yair Benari, Hornsby (AT)

Correspondence Address: FULWIDER PATTON, 6060 CENTER DRIVE, 10TH FLOOR, LOS ANGELES, CA, 90045, US

(21) Appl. No.: 11/387,118

(22) Filed: Mar. 22, 2006

Related U.S. Application Data
(60) Provisional application No. 60/664,689, filed on Mar. 23, 2005.

(51) Int. Cl. G01K 1/08

(52) U.S. Cl. 250/397

(57) ABSTRACT

An electron multiplier detector includes cathode structure defining a plurality of spaced co-planar impact surface segments on which particles impact. These surface segments each have a finite probability of generating at least one electron for each impacting particle having predetermined characteristics. The detector further includes respective sets of electron multiplication dynode segments associated with the impact surface segments, the sets being arranged as substantially parallel arrays extending behind the impact surface segments, and respective means for generating electrostatic and magnetic fields in a space extending from the impact surface segments past the dynode segments, whereby respective streams of electrons cascade and multiply successively along the arrays of dynode segments. Collector structure is provided to receive and detect the streams of electrons downstream of the last dynode segments in the arrays.

### FIELD OF THE INVENTION

This invention relates generally to the detection of particles and is concerned in particular with enhancements of electron multiplier configurations for this purpose.

In the context of this specification, a “particle” may be an ion or other charged particle, a neutral particle or a photon, that is capable of causing an impacted surface to generate an electron. A common application of electron multipliers, however, is the detection of specific ions, for example in mass spectrometers, and hence for convenience, particles to be detected will sometimes be referred to herein as ions.

### BACKGROUND ART

To optimise the usefulness or performance of an electron multiplier, it is often desirable to have a large sensitive input area so that particles can be detected which are incident over a large area.

As well as enabling the detector to have a large sensitive input area, a number of additional requirements for the detector will be necessary if the device is to be used for special applications such as time-of-flight mass spectrometry (TOF-MS). For TOF-MS applications it is critical to accurately measure the arrival time of the ions that are detected over the sensitive input area. To achieve this objective, the detector, at least in a preferred form, should be such as to contribute little or no distortion to the relative measured arrival times of input ions. Expressed another way, if multiple ions arrive at the detector and are spread uniformly over the input area and are all coincident in time, the electrons (resulting from these ions) exiting the final stage of the detector should all impact the final element of the detector (the collector), substantially in temporal coincidence, causing a narrow electrical pulse.

An electron multiplier typically includes an ion impact plate as the first element of the device. This ion impact plate is an integral component of most ion detectors and has the function of converting the input ions, to be detected, into electrons. The emission of low-energy secondary electrons from the impact plate is the desired response to the plate being struck by sufficiently energetic particles, and forms the principal signal to be amplified by the detector. These electrons are sometimes referred to as the signal or signal carrying particles or signal carrying electrons.

In addition to the desired secondary electrons, the incoming signal ions may cause numerous other interactions that may generate particles within the detector. These particles include:
a) Grid ions: Ions that are emitted from the detector's entry grid as a result of an impact on the grid by a signal ion. They can be positive or negative, low energy or high energy.
b) Grid electrons: Electrons that are emitted from the detector's entry grid as a result of an impact on the grid by a signal ion.
c) Grid neutrals: Neutral atoms or molecules that are emitted from the detector's entry grid as a result of an impact on the grid by a signal ion.
d) Impact plate ions: Secondary ions that are emitted from the detector's impact plate as a result of an impact on the plate by a signal ion. They can be positive or negative, low energy or high energy.
e) Impact plate neutrals: Neutral atoms or molecules that are emitted from the detector's impact plate as a result of an impact on the plate by a signal ion.

For time-of-flight mass spectrometry all particles resulting from these interactions within the detector (as distinguished from secondary electron emission from the impact plate) generate unwanted artefact signals in the detector output. Such artefacts are usually seen as unwanted small peaks in the mass spectrum, which are not coincident with the primary signal associated with the incoming ion, and thus add confusion when interpreting the spectrum. It is desirable to eliminate or minimise these artefacts so that they no longer unduly interfere with the intended signal.

A mechanism capable in principle of addressing the problem of the artefact signals is deflection of the signal carrying electrons by means of an electrostatic field in conjunction with a magnetic field, in contrast to the typical environment of most commercial electron multipliers in which deflection is by electrostatic field only. Electron multipliers employing this basic principle were developed and manufactured in the 1960's (See G.W. Goodrich and W.C. Riley, Review of Scientific Instruments, 32 (1961) 846-849). Because these devices utilised magnetic fields in the electron deflection process all other particles were excluded. Magnetic deflection is mass sensitive and as a result ions and neutrals will experience very little or no deflection in a magnetic field designed for electrons.

Devices utilising combined electrostatic and magnetic field deflection functioned well but had an inherent drawback resulting in their disuse by the middle 1970's. If they were to maintain good time coherence (as described above) the size of each of the successive dynode surfaces had to be approximately equal to the size of the ion impact surface. The combined requirement of large impact surface area and small overall detector size left this approach impractical for most applications.

Commonly assigned U.S. Pat. No. 6,982,428 further develops the mechanism just described and proposes specific adaptations for the purpose of focussing the beam of signal carrying electrons. Electrons resulting from the initial ion impact (on the first dynode or ion impact surface) are transferred to a second dynode surface following quasi-cycloidal trajectories dictated by the combined electrostatic/magnetic fields as described above. The second dynode surface is held at a positive voltage with respect to the ion impact surface with a voltage large enough to ensure that the electrons impact the second dynode with sufficient energy to generate secondary electrons. These secondary electrons are again subjected to a similar electrostatic/magnetic field combination so that they are transferred to a third dynode (by the same basic mechanism), generating further secondary electrons. This process is cascaded multiple times within the device resulting in enough secondary electrons to provide a practical electrical signal when intercepted by a collector electrode.

A convenient way to organise this device is described in U.S. Pat. No. 6,982,428, ie to make all of the dynodes from a single resistive surface or plate, so that the voltage difference between each of the dynodes results from a single voltage source applied between the two extreme ends of the resistive plate. Furthermore, the second dynode surface (on the dynode plate) is approximately 90° to the ion impact surface (or first dynode). Therefore electrons from the ion impact surface traverse through an angle of approximately 270° before impacting on the second dynode surface. The remaining dynode surfaces are approximately coplanar with the second dynode surface.

A primary objective of the invention is to amplify signal carrying electrons resulting from the impact of the particles to be detected without degradation of the timing information and while minimising artefact signals in the detector output.

A further objective of the invention is to provide a particle detector with relatively large sensitive area as compared to a relatively small overall size and without the need for electron focussing as proposed in commonly assigned U.S. Pat. No. 6,982,428. The focussing arrangement described in this patent requires considerably more spatial volume for the same sensitive area than the invention described herein.

### SUMMARY OF THE INVENTION

The present invention utilises the basic mechanism described above involving deflection of electrons by an electrostatic field in conjunction with a magnetic field, but provides a number of concepts that render the mechanism practical as an amplifying electron multiplier. In other respects, the invention provides improvements generic to combined electrostatic/magnetic field electron multiplier configurations.

In a first aspect, the invention provides an electron multiplier detector that includes cathode structure defining a plurality of spaced co-planar impact surface segments on which particles impact. These surface segments each have a finite probability of generating at least one electron for each impacting particle having predetermined characteristics. The detector further includes respective sets of electron multiplication dynode segments associated with the impact surface segments, the sets being arranged as substantially parallel arrays extending behind the impact surface segments, and respective means for generating electrostatic and magnetic fields in a space extending from the impact surface segments past the dynode segments, whereby respective streams of electrons cascade and multiply successively along the arrays of dynode segments. Collector structure is provided to receive and detect the streams of electrons downstream of the last dynode segments in the arrays.

The invention further provides, in a second aspect, an electron multiplier detector that includes cathode structure defining an impact surface segment on which particles impact, which surface segment has a finite probability of generating at least one electron for each impacting particle having predetermined characteristics. The detector further includes a plurality of electron multiplication dynode segments arranged in an array, and respective means for generating electrostatic and magnetic fields in a space extending from the impact surface past the dynode segments, whereby said electrons cascade and multiply successively along the array of dynode segments. The impact surface segments and the array of dynode segments are defined by a plate structure of which a side of less width provides an impact surface segment and a side of greater width provides an array of dynode segments.

In its third aspect, the invention provides an electron multiplier detector that includes cathode structure defining an impact surface segment on which particles impact. This surface segment has a finite probability of generating at least one electron for each impacting particle having predetermined characteristics. A plurality of electron multiplication dynode segments are arranged in an array and respective means are provided for generating electrostatic and magnetic fields in a space extending from said impact surface past the dynode segments, whereby said electrons cascade and multiply successively along said array of dynode segments. The array of dynode segments is a continuous dynode having a surface that comprises stripes alternately of electrically resistive material and electrically conductive material, which stripes extend orthogonal to the direction of travel of the streams of electrons.

Throughout this specification there are references to both electrically conductive and electrically resistive surfaces. The difference between these two surfaces is in their surface resistivity and the two terms could be interpreted as relatively low resistivity surfaces (conductive) and relatively high resistivity surfaces (resistive).

Advantageously, each array of dynode segments is a continuous dynode having a surface formed from resistive secondary electron emissive material.

In its first aspect, each of the arrays of dynode segments is preferably a substantially planar continuous surface. The plurality of such planar continuous surfaces are preferably substantially mutually parallel.

Each of the arrays of dynode segments is advantageously provided by a respective structure having a back surface opposed to but spaced from an adjacent set of dynode segments.

The means for generating an electrostatic field may in part comprise an electrically resistive layer on said back surface, and means to apply an electrical voltage gradient along said layer.

Preferably, the means for generating an electrostatic field may further include an electrical circuit for applying respective voltages to said arrays of dynode segments and to said back surfaces, which circuit has said arrays of dynode segments in parallel as a first circuit component and said back surfaces in parallel as a second circuit component, and each of said first and second circuit components in series with complementary electrical resistances.

Although most of the remaining description of the invention refers to the many dynodes (from the second dynode to the collector) as regions existing on a resistive plate, they could be arranged as an array of individual electrodes (discrete dynodes). The claims of this invention are to extend to the same concept but using discrete dynodes in place of the resistive dynode plate.

### BRIEF DESCRIPTION OF THE DRAWINGS

The invention will now be further described, by way of example only, with reference to the accompanying drawings, in which:—

FIG. 1 is a schematic three-dimensional diagram of electron multiplier particle detector apparatus according to an embodiment of the invention;

FIG. 2 is a cross-section on the line 2-2 in FIG. 1; and

FIG. 3 is an electrical circuit diagram for the apparatus of FIG. 1.

### DESCRIPTION OF EMBODIMENTS OF THE INVENTION

The illustrated electron multiplier particle detector includes a set of spaced, uniformly dimensioned plate structures 12 of elongated rectangular cross-section. The wider faces of each structure define respective flat faces 14, 16 coated in electrically resistive material. The narrower face at the top forms an impact surface segment 18 chosen to respond to each impacting particle, in this case ion 5, to be detected by generating a secondary electron.

Surface segments 18 are coplanar and so provide a segmented impact surface for ions 5. Faces 14 are parallel, and are electron emissive so as to define a continuous dynode plate, effectively a continuous array of dynode segments. Faces 16 are opposed to and parallel to dynode plates 12 and serve a purpose to be explained further below. Faces 16 are hereinafter referred to as attractor plates.

A combined electrostatic and magnetic field is provided for controlling the trajectories of secondary electron streams through the apparatus. The electrostatic field is generated by applying voltages to the dynode plates and attractor plates, and also to an entrance mesh 20 above impact surface segments 18. A suitable circuit arrangement for this purpose is described below, with reference to FIG. 3, and electrostatic equipotentials are depicted at 22 in FIG. 2, from which it will be appreciated that the electrostatic field vector is broadly parallel to the page in FIG. 2.

The magnetic field B is generated by a pair of flat plate poles 25, 25a so that its field vector 26 is generally parallel to both faces 14, 16 and mesh 20. The field vector 26 is normal to the page in FIG. 2. Poles 25 may be permanent or electromagnets.

Electrons resulting from the initial ion impact (on the first dynode or ion impact surface 18) are transferred to a second dynode located on dynode plates 14, following quasi-cycloidal trajectories 6 dictated by the combined electrostatic/magnetic fields as described above. These electrons 6 from the impact surface segments 18 traverse through an angle of approximately 270° before impacting on the dynode surface 14. The dynode surface 14 is held at a positive voltage with respect to the impact surface 18 with a voltage large enough to ensure that the electrons impact the dynode surface 14 with sufficient energy to generate secondary electrons. These secondary electrons are again subjected to a similar electrostatic/magnetic field combination so that they are transferred (trajectories 6a) to a third dynode location (by the same basic mechanism), generating further secondary electrons. This process is cascaded multiple times within the device, resulting in respective streams 7 of sufficient secondary electrons to provide a practical electrical signal when intercepted by a collector electrode 30.

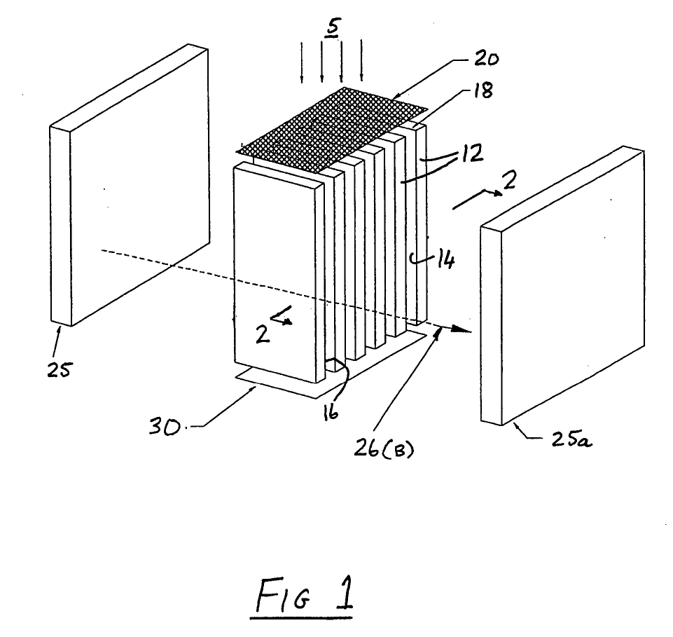

The width of the ion impact surface segments 18 is preferably kept relatively small to limit the overall size of the detector to a practical size. A typical ion impact surface segment width may be anywhere from a fraction of a millimetre to several millimetres. If there was only one dynode plate 14 it would look like a thin device with an ion impact surface at one end with input ion trajectories nearly parallel to the dynode plate (the dynode-to-dynode axis as defined in FIG. 1). (This hypothetical single dynode plate would require an opposing attractor plate, described below as the back surface of an adjacent dynode plate). The ion impact surface could stretch essentially to any length in the axis orthogonal to the dynode-to-dynode axis (into the page in FIG. 2) and orthogonal to the electrostatic field (assuming the magnetic field could be maintained over this extended length). This would result in a long thin ion impact surface. To turn this into a practical device, a number of these assemblies are stacked together as illustrated so that the ion impact surface is now made up of multiple long thin surfaces arranged parallel to each other.

The number of stacked assemblies used in the device is limited only by the required ion impact surface area (and the ability to control the magnetic field over a large area). Due to the spaces between dynode plates, less than 100% of the device's input area will be sensitive to ions. Approximately 50% of the resulting ion input area would be sensitive to ions (ie resulting in output signal from the device). The remaining 50% would provide an opening for the secondary electrons (resulting from ion impact) to enter the cascade of dynodes. This 50% useful-ion-entrance-area compares favourably with that of microchannel plates that are currently the most commonly used device for this type of measurement.

For each of the positions where electrons are transferred from surface to surface it will be important to control both the electrostatic and magnetic fields. Controlling the magnetic fields will be reasonably straightforward in that the preference is for an approximately uniform magnetic field throughout the device. An enhancement described below will require the magnetic field strength to be decreased in the vicinity of the output stage of the device (the collector 30).

Over the ion impact surface segments 18 (1^{st} dynode) the electrostatic field can be controlled, preferably by positioning nearly ion-transparent and electrically conductive mesh 20 over the ion impact surface 18. Applying a voltage to the mesh will set up a controlled electrostatic field over the ion impact surfaces. A single metal mesh 20 positioned to be parallel to the ion impact surfaces 18 will satisfy this requirement.

Where the electron transfers are occurring between dynodes on the dynode plate the electrostatic field can be controlled by applying the appropriate voltages to the back face 16 of the adjacent dynode plate 14 which faces the dynode plate 14 to be controlled. This can be accomplished conveniently by arranging the back face 16 of the dynode plate 14 to be coated with a resistive material or made resistive in some other manner. This will enable the application of a near uniform electrostatic field over the dynode plate by applying the appropriate voltages at each end of the resistive coating on the back face of the opposing dynode plate. As already noted the resistive surface on the back of the dynode plate will be referred to here after as the attractor plate 16.

Most of the techniques described in the remainder of this description will be necessary for practical implementation of the device as described herein. They will also be applicable to many other devices, and particularly to others utilising combined electrostatic/magnetic fields for electron deflection within an electron multiplier device. The claims of this invention are to extend to these other devices.

The attractor plate resistive coating has a secondary purpose. If it is applied to the back of the same substrate that is used for the dynode plate there will be a significant electrical capacitance between the two sides of the substrate. This capacitance will result in enhanced operational performance for some applications. Because the instantaneous current supplied by an electron multiplier during an output pulse is orders of magnitude greater than the electrical current supplied to the device by its associated high voltage supply, it must draw charge from its internal capacitance to supply the current that forms the output pulse. The high voltage supply then replenishes the charge to the internal capacitance through the resistive network (formed by the dynode plate's resistive coating in this case). As a result the maximum pulse amplitude or maximum number of pulses delivered during a burst of pulses is limited by the device's internal capacitance. Increasing this capacitance, formed by the resistive coatings on both sides of the dynode plate substrate described above, will increase the device's pulse dynamic range and ability to handle large ion bursts without performance degradation.

The internal capacitance will be further increased by decreasing the thickness of the substrate and by selecting a substrate with high dielectric constant. Therefore these parameters must be considered when designing the details of the device.

The last dynode plate, at the far right end of the device, as seen in FIGS. 1 and 2, has no need for a resistive coating on its right hand side as there are no adjacent dynode plates on this side. Therefore, this surface can be coated with a conductive surface in place of the resistive surface to achieve the same contribution to its internal capacitance. This conductive surface must be electrically attached to part of the device's circuit to be effective. Local earth would be a good choice for this connection.

To ensure time coherence between electron transfers originating from the multiple ion impact surface segments 18 (and hence their output pulses) it is important that these surface segments are substantially all coplanar with each other. To accomplish this the dynode plates may be attached together in some manner (for example with screws or with glue). Their end surfaces are then simultaneously machined (together as a single piece) to flatten the ion impact surface segments all at once (for example with a surface grinder). From this point it will be convenient that the assembly never be disassembled so that the ion impact surface segments remain as machined and coplanar.

As can be seen in FIG. 2, some of the ions will miss the ion impact surface segments and continue on a path parallel or nearly parallel to the dynode plates 14. If any of these ions strike the dynode plate they could generate secondary electrons which may cause an artefact signal that is not coincident with the primary ion signal. Therefore it is important that the assembly is configured and oriented at a slight angle before machining so that incoming ions will only have an opportunity to strike the attractor plate 16, where any secondary electrons will be retarded (or suppressed) by the electrostatic field and therefore will not result in an output signal.

An alternative approach to eliminating these artefact signals is to position an appropriate, segmented mask above the ion input area (parallel to the ion entrance mesh 20 shown in FIG. 1) that physically blocks ions whose trajectories would end on the dynode plate. This could be implemented by positioning a thin metallic plate adjacent to the ion entrance grid that has slots corresponding to the position above the ion impact surface segments 18 and carefully aligning it to block the area above the gap between the attractor and dynode plates.

For most dynode materials it will be necessary to process the ion impact surface after it is machined to ensure it has characteristics suitable for ion to electron conversion. This can be accomplished by vacuum coating the surface with a suitable high secondary electron yield material. If this material is conductive it will be important that the evaporation source is positioned at a large angle from the surface normal during evaporation and oriented so that the evaporated material coats very little of the resistive dynode plates or resistive attractor plates or that some other method is employed to control the position of the coating.

A significant issue to be addressed is how to maintain appropriate electrostatic fields as changes are made to the dynode-to-dynode voltages. In normal operation the dynode-to-dynode voltages of an electron multiplier are increased periodically to maintain a desired gain as the dynode surfaces degrade with usage. In the suggested implementation this is accomplished by periodically increasing the voltage applied between the two ends of the resistive dynode plate. Because the dynode plates are resistive they will act as voltage dividers, distributing the increased voltage proportionately to each dynode position. Appropriate use of zener diodes provides a convenient way of applying the appropriate voltages to the various points that control the electrostatic fields while compensating for changes in the overall dynode plate voltage.

FIG. 3 shows a possible circuit diagram of how to arrange zener diodes to achieve the desired electrostatic fields within the device. The dynode plates 14 are electrically connected in parallel with each other, and each of the attractor plates 16 are electrically connected in parallel with each other. The resistive dynode plate 14 and resistive attractor plate shown in FIG. 3 are representing all of the dynode plates connected in parallel and all of the attractor plates connected in parallel, respectively. For the circuit to perform appropriately it is desirable that the total resistance of the attractor plates connected in parallel is greater than the total resistance of the dynode plates connected in parallel. This will ensure that the majority of the electrical current flowing between the applied high voltage 40 and local earth 41 will pass through the resistive dynode plate 14. This will enhance the linear operation of the device at high signal levels.

Nominally, if the total voltage developed across zener diodes D1 and D2 equals the total voltage developed across zener diodes D3 and D4 the electrostatic field strength will be uniform over the entire dynode plate and independent of the applied high voltage 40. This will be true if the value of all trimming resistors is 0 ohms, the ends of dynode plate 14 and attractor plate 16 where voltages are applied are opposite each other and the two plates are parallel to each other. It is reasonable to achieve these requirements within the accuracy needed for practical operation. The zener diodes D1, D2, D3 and D4 are shown in sets of two diodes in series so that an appropriate interim voltage can be connected to the ion entrance mesh 20.

Zener diode D5 is included to ensure that electrons emitted from the ion impact surface segments 18 develop sufficient energy to generate a significant number of secondary electrons when striking the dynode plate. This is particularly important for this first electron interaction as it will usually dominate the overall detection efficiency of the detector.

All of the zener diodes in the circuit diagram can be replaced with resistors of the appropriate values but this will result in some compromise in the device's performance. Analysis indicates that the primary compromise will be a shortened operational life of the device.

The trimming resistors are included to address another issue. If the electrostatic field remains constant throughout the operational life of the device the positions where electron trajectories strike the dynode plate will remain fixed and result in a mostly unused dynode surface interspersed with heavily worn or degraded spots where the electrons impact the surface. This can lead to rapid aging, perhaps rendering the device impractical for many applications. Appropriate selection of trimming resistor values will result in a slow change in the electrostatic field during the operational life of the device as the applied high voltage 40 is increased. This will result in a slow change in trajectory length and thus a change of electron strike position on the dynode plate. Appropriate choice of trimming resistor values will ensure that the dynode plate is degraded uniformly during the operational life of the detector and thus extend its operational life. The three trimming resistors are shown to indicate the various positions that they may be positioned in the circuit. It is likely that only one or two of these resistors will be necessary to achieve full performance.

For most configurations it will be important to include a zener diode or resistor between the end of the attractor plate and local earth (shown as D6 in FIG. 3). This is to maintain a sufficiently high electrostatic field in the vicinity of the collector 30 to ensure that most of the final stage electrons reach the collector. This requirement assumes that the collector is held at local earth potential. In some configurations no zener diode or resistor will be required in position D6. The appropriate electrostatic field could be generated by positioning the collector very close to the dynode/attractor assembly and maintaining the collector voltage at the same voltage that is applied to the end of the attractor plate.

Local earth is shown in FIG. 3 as a convenient way to designate the potential of the collector. For some applications this will actually be held at true earth potential. However, there are many applications where it is desirable to electrically float the entire device to another voltage. In these cases the designated local earth may be held at any potential with respect to earth and the important issues are only the relative potentials of each of the components.

To achieve practical performance it may be preferable to apply thin conductive stripes to the resistive dynode plate 14. These stripes are parallel to the equipotentials that would exist on a resistive dynode plate of ideal uniform resistance. They are parallel to the intersection of the dynode plate and the ion impact surface, and extend orthogonal to the direction of travel of electron streams 7. As the stripes will effectively result in a local electrical short of the resistive material over which they lie, they will reduce the overall resistance of the dynode plate and this must be taken into consideration when choosing the resistivity of the resistive material. The stripes will contribute to the device's performance in several ways:
A. The conductive stripes will force the equipotentials on the resistive surface to be accurately aligned to be perpendicular to the dynode-to-dynode axis and parallel to the ion impact surface. This will effectively eliminate or minimise variations from the appropriate electrostatic field direction caused by local irregularities in the resistive material. The accuracy of the electrostatic field alignment will only be limited by the accuracy of coating or printing the lines onto the resistive surface, which will be adequate using conventional coating/printing techniques. Accurate alignment of the electrostatic fields will ensure that all electrons follow the appropriate paths and therefore will not be lost from the device or impact on inappropriate portions of the dynode plate, which could result in low gain, shortened operational life or distortion to the detector's output pulse shape.
B. The conductive stripes will effectively average out most non-uniformities in the resistive surface and therefore result in a more uniform linear resistivity (ohms per millimetre) distribution along the dynode-to-dynode axis. This is important to ensure that the voltages generated by the resistive surfaces on the dynode plate stay in step with the voltages generated on the attractor plate to control the direction of the electrostatic field and the number of electron-dynode interactions.
C. The dynode plate linear resistivity (ohms per millimetre) may be purposely adjusted by adjusting the width or spacing of the conductive stripes. This will enable the design of localised variations in voltage distribution of both the dynode plate and attractor plate. This technique will likely be important for arranging the appropriate electrostatic field shape between the ion impact surface and beginning of the dynode plate where inappropriate field shape could lead to electron transfer efficiencies so low as to render the device impractical for most applications.
D. The conductive stripes will effectively increase the internal capacitance of the area covered by the conductive stripes. Electrons emitted from the conductive surface will utilise the charge stored in the capacitance developed from the entire area of the stripe. In contrast, electrons emitted from the resistive areas of the dynode surface will have a significant resistance in series with most of capacitance that could contribute charge to the surface depleted by the loss of electrons. This will result in a significant time constant to be associated with the process of charge replenishment of the resistive area. For this reason it is useful to arrange the stripes so that they occupy as much of the dynode plate surface as is practical (limited by the requirement that the surface must be effectively a resistive surface).
E. The conductive stripes may be made from a material with different secondary electron yield material than the resistive material. In effect this adds flexibility to the choice of both the resistive material and the conductive stripe material. Each can be selected for their optimal properties without the need to compromise as would be necessary when one material serves as both resistive voltage divider and high secondary electron emitter. Use of appropriate materials for the conductive stripes can improve the overall gain, linearity and operating life of the device.

Items A, B and C are applicable to the attractor plate as well as the dynode plate. Therefore applying conductive stripes to the attractor plate will further enhance the device's performance.

For most applications, to be useful the device must deliver an electrical pulse into an electrical wire in response to ions incident on the ion impact surface. Most of this description has referred to electrons traversing free space (as opposed to being part of the conduction current in a conductor or wire). To convert these free-space electrons into an electrical signal in a wire they must be intercepted by an electrode that is electrically connected to the wire. Hereafter this electrode is referred to as a collector or an anode. For the collector 30 to be effective it must satisfy two basic criteria:
A. It must be shaped, positioned and electrically biased so that it intercepts most of the electrons that are carrying the signal.
B. The electrostatic field above the portion of the collector that intercepts the electrons must be electrostatically retarding for secondary electrons that are emitted from the collector surface, so that most of the secondary electrons emitted from the collector due to electron impact are deflected back onto the same collector electrode.

There are numerous ways to satisfy these criteria in this device. Probably the simplest is to arrange the dynode plate and attractor plate assembly so that the end farthest from the ion impact surface looks much the same as the ion impact end with the input grid replaced with the collector electrode. The secondary electrons generated by the cascade of electron interactions pass beyond the ends of the attractor and dynode plates onto the collector as shown in FIG. 2. It will be important to arrange the electrostatic and magnetic fields so that the radius of curvature of the electrons to be intercepted by the collector is large enough so that the electrons are intercepted and not merely deflected onto the back of the dynode plate. This may be accomplished by selecting the appropriate value for the zener diode D6 (shown in FIG. 3) or appropriate spacing between the collector and the dynode/attractor assembly or by a local decrease in magnetic field strength or a combination of any or all of these methods. This assumes that the nominal potential on the collector is held at local earth. In this case increasing the voltage rating of zener diode D6 will increase the electrostatic field in the area of the collector and therefore increase the radius of curvature of electron trajectories in this area. Alternatively, or in addition to this technique, decreasing the magnetic field strength in this area will cause the same effect.

The collector shown in FIGS. 1 and 2 is a simple continuous flat conductive plate, which will likely be the most practical design for most applications. However, this collector plate could be made as several segmented parts so that each segment only intercepts electrons emitted from a single dynode plate or several (but not all) dynode plates. This will enable the device to take advantage of the multiple anode collection techniques utilised by many time-of-flight mass spectrometers. (See Barbacci, Russel, Schultz, Holecek, Ulrich and Burton, Proc. ASMS Conference on Mass Spectrometry and Allied Topics, Palm Springs, Jun. 1-5, 1997 and Koomen, Barbaci, Russel, Schultz, Ulrich and Burton, Proc. ASMS Conference on Mass Spectrometry and Allied Topics, Dallas, Jun. 13-17, 1999 and Gonin, Fuhrer and Schultz, Proc. ASMS Conference on Mass Spectrometry and Allied Topics, Long Beach, Jun. 11-15, 2000.) This multiple collector design will also enable the device to be used as a linear array detector, where the electrical signals from each of the collector segments will correspond to different input ion positions.

The device may be further enhanced by interfacing it to a conventional charge coupled array detector. This may be arranged with a photosensitive charge coupled array by first converting the electron signal to photon signal by positioning a scintillator or phosphor at the collector position. Alternatively, a charge sensitive charged coupled array could be used directly in place of the collector.

Yet another collector alternative is to replace the collector plate or collector segments with a scintillator or scintillators which generate(s) light as a result of electron impact. The light signal can be transmitted to a photo-detector through a fiber optic cable or by another method such as physical contact between the scintillator and the photo-detector. This will enable a convenient method of extracting the signal from the device when it is electrically floated. When using this technique it will be necessary to extract the electrical charge deposited on the scintillator by the electrons. Otherwise, the scintillator will slowly develop an electrical charge with use until the incident electrons are deflected away rendering the device ineffective. Covering the scintillator with a nearly transparent conductive mesh that is electrically connected to local earth will satisfy this requirement.

Because these devices utilised magnetic fields in the electron deflection process all other particles were excluded. Magnetic deflection is mass sensitive and as a result ions and neutrals will experience very little or no deflection in a magnetic field designed for electrons. The only particles that will reach the dynode plate in this device are electrons that originate at the ion impact surface with low energy. Therefore the device will generate minimal artefact signals in TOF-MS applications.

I claim:

1. An electron multiplier particle detector, comprising:
cathode structure defining a plurality of spaced co-planar impact surface segments on which particles impact, which surface segments each have a finite probability of generating at least one electron for each impacting particle having predetermined characteristics;
respective sets of electron multiplication dynode segments associated with said impact surface segments, the sets being arranged as substantially parallel arrays extending behind said impact surface segments;
respective means for generating electrostatic and magnetic fields in a space extending from said impact surface segments past said dynode segments, whereby respective streams of electrons cascade and multiply successively along said arrays of dynode segments; and
collector structure to receive and detect said streams of electrons downstream of the last dynode segments in said arrays.

2. A particle detector according to claim 1, wherein each said array of dynode segments is a continuous dynode having a surface formed in resistive secondary electron emissive material, and further including means to apply an electrical voltage gradient along said continuous dynode surface.

3. A particle detector according to claim 2, wherein each said array of dynode segments is a substantially planar continuous surface, and said planar continuous surfaces are substantially mutually parallel.

4. A particle detector according to claim 1, wherein each said array of dynode segments is provided by a respective structure having a back surface opposed to but spaced from an adjacent said array of dynode segments.

5. A particle detector according to claim 4, wherein said means for generating an electrostatic field in part comprises an electrically resistive layer on said back surface, and means to apply an electrical voltage gradient along said layer.

6. A particle detector according to claim 2, wherein each said array of dynode segments is provided by a respective structure having a back surface opposed to but spaced from an adjacent said array of dynode segments, wherein said means for generating an electrostatic field in part comprises an electrically resistive layer on said back surface and means to apply an electrical voltage gradient along said layer, and wherein said electrically resistive layers on said back surfaces and said continuous dynode are arranged to define an internal capacitance for said detector, capable of contributing to the current of the detected electron pulse.

7. A particle detector according to claim 6, configured and oriented so that particles that pass between said spaced, co-planar impact surface segments strike said back surfaces before reaching said dynode segments, and are thereby suppressed against detection.

8. A particle detector according to claim 4, configured and oriented so that particles that pass between said spaced, co-planar impact surface segments strike said back surfaces before reaching said dynode segments, and are thereby suppressed against detection.

9. A particle detector according to claim 8, wherein said back surface comprises stripes alternately of electrically resistive material and electrical conductive material, which stripes extend orthogonal to the direction of travel of said streams of electrons.

10. A particle detector according to claim 9, wherein the stripes of electrically conductive material are positioned adjacent to stripes of said electrically resistive material.

11. A particle detector according to claim 5, wherein said back surface comprises stripes alternately of electrically resistive material and electrical conductive material, which stripes extend orthogonal to the direction of travel of said streams of electrons.

12. A particle detector according to claim 11, wherein the stripes of electrically conductive material are positioned adjacent to stripes of said electrically resistive material.

13. A particle detector according to claim 6, wherein said back surface comprises stripes alternately of electrically resistive material and electrical conductive material, which stripes extend orthogonal to the direction of travel of said streams of electrons.

14. A particle detector according to claim 13, wherein the stripes of electrically conductive material are positioned adjacent to stripes of said electrically resistive material.

15. A particle detector according to claim 5, wherein said means for generating an electrostatic field includes an electrical circuit for applying respective voltages to said arrays of dynode segments and to said back surfaces, which circuit has said arrays of dynode segments in parallel as a first circuit component and said back surfaces in parallel as a second circuit component, and each of said first and second circuit components in series with complementary electrical resistances.

16. A particle detector according to claim 15, wherein the total electrical resistance of said back surfaces is greater than the total electrical resistance of the arrays of dynode segments.

17. A particle detector according to claim 15, where said complementary electrical resistances are replaced by one or more Zener diodes.

18. A particle detector according to claim 17, where said complementary electrical resistances are replaced by one or more Zener diodes and one or more of the included zener diodes has an associated electrical resistance element electrically connected in series with the respective zener diode to ensure that the electrostatic field in the region of the dynode segments varies as the voltage applied to the device is varied which is arranged for varying the impact zones of said electron streams on said dynode segments.

19. A particle detector according to claim 1, wherein said impact surface segments and said arrays of dynode segments are defined in pairwise fashion by plate structures of rectangular cross-section, a side of less width providing an impact surface segment and a side of greater width providing an array of dynode segments.

20. A particle detector according to claim 19, wherein said plate structures are fastened together as an assembly, and the impact surface segments simultaneously machined co-planar.

21. A particle detector according to claim 1, configured so that particles that are not on a trajectory to impact said spaced, co-planar impact surface segments are prevented from reaching said collector means, and are thereby suppressed against detection.

22. A particle detector according to claim 21, wherein the detector is so configured by providing a segmented mask complementary to the impact surface segments.

23. A particle detector according to claim 1, further including one or more adjustable electrical resistances arranged for varying the impact zones of said electron streams on said dynode segments.

24. A particle detector according to claim 1, wherein each said array of dynode segments is a continuous dynode having a surface that comprises stripes alternately of electrically resistive material and electrically conductive material, which stripes extend orthogonal to the direction of travel of said streams of electrons.

25. A particle detector according to claim 24, wherein the electrically conductive material is of different secondary electron yield than the electrically resistive material.

26. A particle detector according to claim 24, wherein the stripes of electrically conductive material are positioned adjacent to stripes of said electrically resistive material.

27. An electron multiplier particle detector, comprising:
cathode structure defining an impact surface segment on which particles impact, which surface segment has a finite probability of generating at least one electron for each impacting particle having predetermined characteristics;
a plurality of electron multiplication dynode segments arranged in an array; and
respective means for generating electrostatic and magnetic fields in a space extending from said impact surface past said dynode segments, whereby said electrons cascade and multiply successively along said array of dynode segments;
wherein said impact surface segments and said array of dynode segments are defined by a plate structure of which a side of less width provides an impact surface segment and a side of greater width provides an array of dynode segments.

28. A particle detector according to claim 27, wherein said array of dynode segments is a continuous dynode having a surface formed in resistive secondary electron emissive material.

29. A particle detector according to claim 27, wherein said array of dynode segments is a continuous dynode having a surface that comprises stripes alternately of electrically resistive material and electrically conductive material, which stripes extend orthogonal to the direction of travel of said streams of electrons.

30. A particle detector according to claim 29, wherein the electrically conductive material is of different secondary electron yield material than the electrically resistive material.

31. A particle detector according to claim 29, wherein the stripes of electrically conductive material are positioned adjacent to stripes of said electrically resistive material.

32. An electron multiplier particle detector, comprising:
cathode structure defining an impact surface segment on which particles impact, which surface segment has a finite probability of generating at leat one electron for each impacting particle having predetermined characteristics;
a plurality of electron multiplication dynode segments arranged in an array; and
respective means for generating electrostatic and magnetic fields in a space extending from said impact surface past said dynode segments, whereby said electrons cascade and multiply successively along said array of dynode segments;
wherein said array of dynode segments is a continuous dynode having a surface that comprises stripes alternately of electrically resistive material and electrically conductive material, which stripes extend orthogonal to the direction of travel of said streams of electrons.

33. A particle detector according to claim 32, wherein the electrically conductive material is of different secondary electron yield material than the electrically resistive material.

34. A particle detector according to claim 32, wherein the stripes of electrically conductive material are positioned adjacent to stripes of said electrically resistive material.
